(19) United States
(12) Patent Application Publication
(10) Pub. No.: US 2011/0115730 A1
(43) Pub. Date: May 19, 2011

(54) MOBILE TERMINAL HAVING TOUCH SCREEN AND METHOD OF MEASURING GEOMETRIC DATA THEREIN

(75) Inventors: Ji Hye KIM, Suwon-si (KR); Jae Ho KIM, Seongnam-si (KR); Jae Sung SHIM, Anyang-si (KR); Sang Won LEE, Suwon-si (KR)

(73) Assignee: SAMSUNG ELECTRONICS CO. LTD., Suwon-si (KR)

(21) Appl. No.: 12/943,527

(22) Filed: Nov. 10, 2010

(30) Foreign Application Priority Data
Nov. 18, 2009 (KR) 10-2009-0111644

(51) Int. Cl. G06F 3/041

(52) U.S. Cl. 345/173

(57) ABSTRACT

A terminal including a touch screen and a method of measuring geometric data therein are provided. The method includes determining whether at least two touch events are detected in a geometric data measuring mode of measuring at least one of a length, an area, and a volume, calculating the geometric data from the detected touch events, and displaying the calculated geometric data. With the method, the terminal may calculate length, area, and volume from at least two touch events detected on the touch screen.

### PRIORITY

This application claims the benefit under 35 U.S.C. §119(a) of a Korean patent application filed on Nov. 18, 2009 in the Korean Intellectual Property Office and assigned Serial No. 10-2009-0111644, the entire disclosure of which is hereby incorporated by reference.

### BACKGROUND OF THE INVENTION

1. Field of the Invention

The present invention relates to a terminal having a touch screen and a method of measuring geometric data therein. More particularly, the present invention relates to a method of measuring geometric data such as length, area, and volume of a specific object in a terminal having a touch screen and a terminal for performing the same.

2. Description of the Related Art

Touch screens are devices in which a display unit and an input unit are implemented as a single unit and an image or various shaped figures can be input. Due to the integration of the display unit and the input unit, the touch screens are being mounted in various terminals such as small terminals such as mobile terminals. Since there is no need to provide a separate input unit, the terminals having the touch screens may have large display units. Due to refined design and convenient use, many users prefer using the terminals having the touch screens.

In general, a user uses the terminal having a touch screen to input and store data and to check the stored data. Thus, developments and researches are demanded to use the terminal having a touch screen other than the above-mentioned use.

### SUMMARY OF THE INVENTION

An aspect of the present invention is to address the above mentioned problems and/disadvantages and to provide at least the advantages described below. Accordingly, an aspect of the present invention is to provide a terminal having a touch screen and a method of measuring geometric data in the terminal.

In accordance with an aspect of the present invention, a method of measuring geometric data in a terminal having a touch screen is provided. The method includes determining whether at least two touch events are detected in a geometric data measuring mode of measuring at least one of a length, an area, and a volume, calculating the geometric data from the detected touch events, and displaying the calculated geometric data.

In accordance with an aspect of the present invention, a geometric data measuring terminal is provided. The terminal includes a touch screen including a touch sensor for detecting at least two touch events in a geometric data measuring mode of measuring at least one of a length, an area, and a volume, a display unit for displaying the geometric data and a control unit for calculating the geometric data using the at least two touch events detected by the touch screen.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a block diagram schematically illustrating a configuration of a terminal according to an exemplary embodiment of the present invention;

FIG. 2 is a view illustrating a length measuring screen according to an exemplary embodiment of the present invention;

FIG. 3 is a view illustrating an area measuring screen according to an exemplary embodiment of the present invention;

FIG. 4 is a view illustrating a volume measuring screen according to an exemplary embodiment of the present invention;

FIG. 5 is a flowchart illustrating a method of measuring geometric data according to an exemplary embodiment of the present invention;

FIG. 6 is a flowchart illustrating a method of measuring a length according to an exemplary embodiment of the present invention;

FIG. 7 is a flowchart a method of measuring an area according to an exemplary embodiment of the present invention; and

FIG. 8 is a flowchart a method of measuring a volume according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The term ‘terminal’ refers to an information processing device to process data received from an external terminal or from various data input by a user, and having a touch screen. The terminal may include a computer, a laptop computer, a mobile communication terminal, a Personal Digital Assistant (PDA), an electronic dictionary, and a Portable Multimedia Player (PMP).

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, exemplary embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring the subject matter of the present invention.

FIG. 1 is a block diagram schematically illustrating configuration of a terminal according to an exemplary embodiment of the present invention.

Referring to FIG. 1, the terminal includes a touch screen 110, a control unit 120, and a storage unit 130.

The touch screen 110 includes a display unit 115 and a touch sensor 117 and performs a function of displaying data input by a user. In more detail, the display unit 115 displays various types of information on status and operations of the terminal under the control of the control unit 120. The display unit 115 displays points where touch events are detected on the touch screen 110, in the order of detections of the touch events, by connecting the points to each other under the control of the control unit 120 in a geometric data measuring mode. The display unit 115 may display a length, an area, and a volume of at least two touch events detected under the control of the control unit 120.

The touch sensor 117 is attached to the display unit 115 and may sense a touch event that an input tool, such as a finger of a user or a stylus, touches the surface of the touch screen 110 and is released therefrom. The touch sensor 117 may check a coordinate corresponding to the point where the touch event is detected and may transmit the checked coordinate to the control unit 120. The control unit 120 may measure geometric data of a specific object using the transmitted coordinate of the point where the touch event is detected. Here, the term ‘geometric data’ refers to a length, an area, or a volume of a specific object, and is calculated from at least two touch events input by a user.

The control unit 120 controls overall status and operations of respective elements of the terminal. The control unit 120 may calculate the geometric data using the coordinates corresponding to points where the touch events are detected, transmitted from the touch screen 110. The control unit 120 may temporally store coordinates corresponding to the points where the touch events are detected in a buffer (not shown) or in the storage unit 130.

When two touch events are detected through the touch screen 110, the control unit 120 may calculate a length of a side forming a specific object using coordinates of the points where the two touch events are detected. When at least three touch events are detected through the touch screen 110, the control unit 120 may calculate lengths of respective sides and areas of the specific object, using coordinates of the points where the at least three touch events are detected. When at least four touch events are detected through the touch screen 110, the control unit 120 may calculate lengths of respective sides and total area or a volume of the specific object, using coordinates of the points where the at least four touch events are detected. To these ends, the control unit 120 includes a length calculator 123, an area calculator 125, and a volume calculator 126.

The length calculator 123 may calculate a length between at least two points where touch events are detected using coordinates of the points where the at least two touch events are detected through the touch screen 110. For example, when a coordinate of a point where a first touch event is detected is (0, 0), and a coordinate of a point where a second touch event is detected is (0, 4), the distance between the points may be ‘4’.

The distance between at least two coordinates may be calculated in various ways. When two coordinates are positioned on the same axis, the distance between two coordinates may be calculated by subtraction. When two coordinates are not positioned on the same axis, the distance may be calculated by a method of calculating the length of a side of a triangle.

For example, the calculated distance between two coordinates becomes a length that a user wants to measure. The coordinate of a position where a touch event is detected may be a positional value of a pixel. The distance between two coordinates may be checked with the number of pixels. Thus, it must be checked how many pixels form the display unit of the touch screen when the terminal is manufactured, and it is thereby defined how many pixels correspond to a distance of 1 cm.

When at least two distances, as distances between points where at least three touch events are detected, are calculated by the length calculator 123, the area calculator 125 calculates an area from the at least two calculated distances. However, when an area calculation of a circle is selected by a user, the area calculator 125 may instead calculate the area of the circle using a single length.

In order to calculate an area, the area calculator 125 must check a figure formed by connecting at least three points where touch events are detected to each other in the order of detections of the at least three touch events. That is, the area calculator 125 determines whether a figure formed by the touch events is a triangle, a quadrangle, or a polygon having at least five sides.

Next, the area calculator 125 calculates an area of the checked figure using the calculated length and a mathematical formula of calculating an area. For example, the figure formed by touch events is a quadrangle having respective sides of 1 cm and 5 cm, the area calculator 125 multiplies 5 cm by 1 cm using a mathematical formula of calculating an area of a quadrangle. Otherwise, when the figure formed by touch events is a triangle having sides of 2 cm and 3 cm, the area calculator 125 may calculate an area by multiplying 2 cm by 3 cm using a mathematical formula of calculating an area of a triangle.

The volume calculator 126 may calculate a volume using an area calculated by the area calculator 125 and a height input by a user. In this case, the volume calculator 126 applies different mathematical formulas of calculating a volume according to figures selected by a user. For example, when a hexahedron is selected by a user, the volume calculator 126 may calculate a volume by applying the calculated area and a height to a mathematical formula of calculating a volume.

The control unit 120 controls the display unit 115 to display geometric data calculated by the length calculator 123, the area calculator 125, and the volume calculator 126, using coordinates of at least two positions where touch events are detected. The control unit 120 may control the display unit 115 to connect the positions where touch events are detected to each other in the order of detections of the touch events to form a line and to display the same.

The storage unit 130 may store applications and various types of information related to functions performed in the terminal. The storage unit 130 stores mathematical formulas of calculating a length, an area, and a volume, in order to determine geometric data from at least two touch events detected through the touch screen 110. The control unit 120 may calculate geometric data using the stored mathematical formulas.

The terminal may check at least two positions where touch events are detected through the touch screen 110 and may calculate a length, an area, and a volume. The terminal may provide various data to a user by displaying the calculated geometric data. Thus, a user may easily confirm geometric data such as a length, an area, and a volume of a desired object using the terminal.

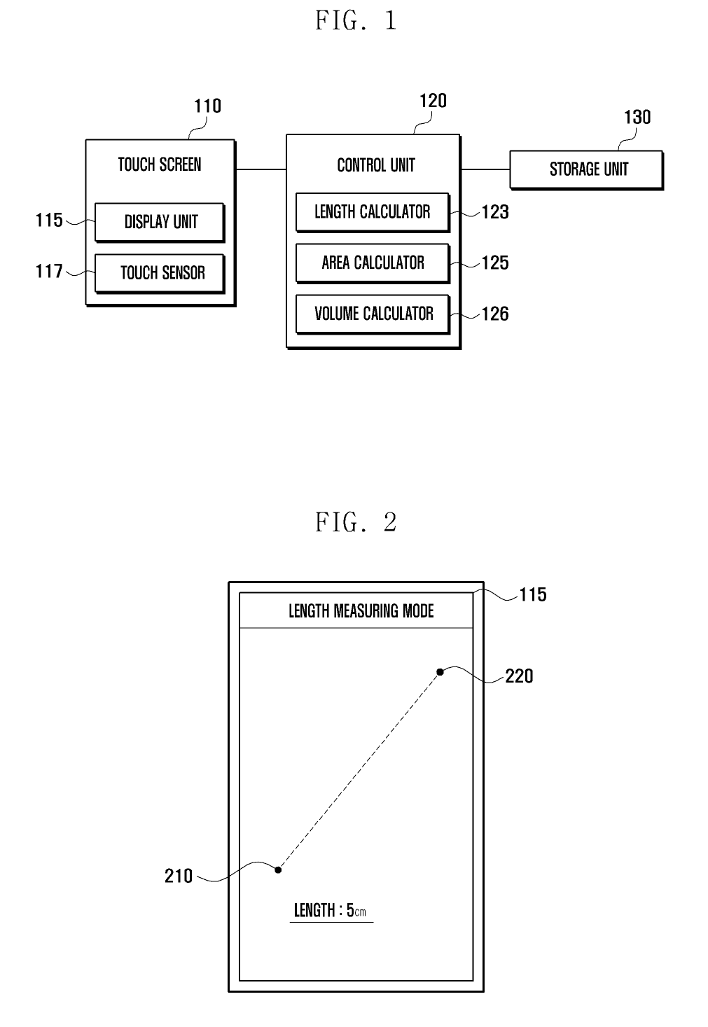

Next, a screen displaying geometric data by a user's choice is described with reference to FIGS. 2 to 4.

FIG. 2 is a view illustrating a length measuring screen according to an exemplary embodiment of the present invention.

Referring to FIG. 2, a user inputs an object, a length of which is to be measured, on the touch screen 110 of the terminal. The user sequentially touches positions where two corners of a section of the object are to be entered on the touch screen 110. Then, as illustrated in FIG. 2, the display unit 115 of the terminal connects the position 210 where a first touch event is detected to the position 220 where a second touch event is detected, and displays a line connecting the two positions. When the line connecting the position 210 where the first touch event is detected to the position 220 where the second touch event is detected is, for example, 5 cm, the display unit 115 displays the calculated length 5 cm. The line connecting the position 210 where the first touch event is detected to the position 220 where the second touch event is detected may be displayed in the form of a solid line or a dotted line.

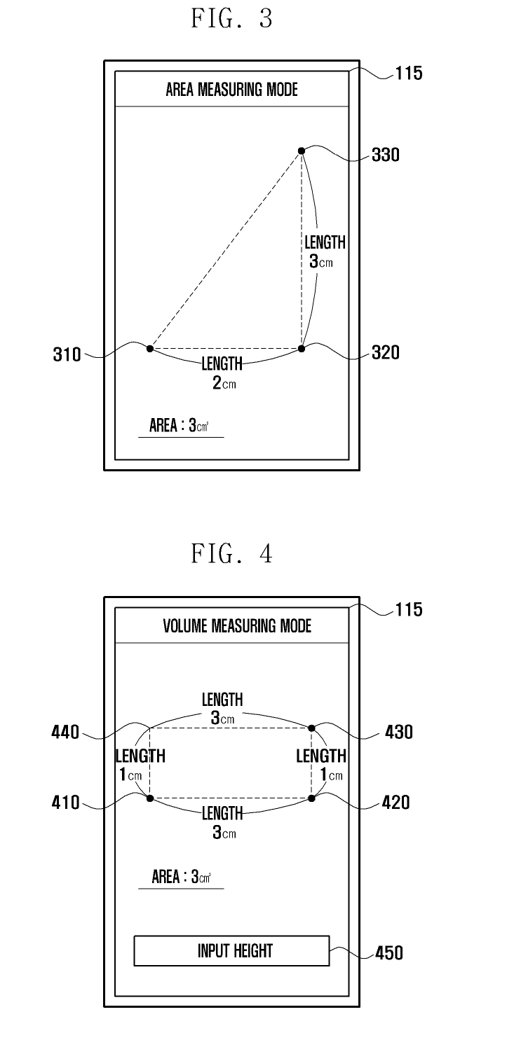

FIG. 3 is a view illustrating an area measuring screen according to an exemplary embodiment of the present invention.

Referring to FIG. 3, a user inputs an object, an area of which is to be measured, on the touch screen 110. The user sequentially touches at least three positions where corners of the object are positioned on the touch screen 110. Then, the terminal calculates an area, using coordinates of at least three positions where touch events are detected transmitted from the touch screen 110.

For example, assume that a user inputs three touch events in order to calculate an area of a triangular object. Then, as illustrated in FIG. 3, the display unit 115 displays a position 310 where a first touch event is detected, a position 320 where a second touch event is detected, and a position 330 where a third touch event is detected. The display unit 115 connects the positions where the touch events are detected, in the order of detections of the touch events, into a line, and displays the line.

Next, the display unit 115 displays the distance between the position 310 where the first touch event is detected and the position 320 where the second touch event is detected as a length, for example, 2 cm. Moreover, the display unit 115 displays the distance between the position 320 where the second touch event is detected and the position where the third touch event is detected as a length, for example, 3 cm. The display unit 115 displays an area 3 cm² calculated from a mathematical formula of calculating an area of a triangle.

FIG. 4 is a view illustrating a volume measuring screen according to an exemplary embodiment of the present invention.

Referring to FIG. 4, a user inputs an object, a volume of which is to be measured, on the touch screen 110 of the terminal. The user sequentially touches at least three positions where corners of the object are positioned on the touch screen 110 in order to calculate an area of a face of the object.

For example, assume that the user inputs four touch events in order to calculate an area of a cube. Then, as illustrated in FIG. 4, the display unit 115 displays a position 410 where a first touch event is detected, a position 420 where a second touch event is detected, a position 430 where a third touch event is detected, and a position 440 where a fourth touch event is detected. The display unit 115 connects the positions where the touch events are detected to each other into lines, in the order of detections of the touch events, and displays the lines. In this case, the display unit 115 displays the positions where the touch events are detected together with lengths of the lines. In other words, as illustrated in FIG. 4, the display unit 115 displays, for example, 3 cm as a length of a line connecting the position 410 where the first touch event is detected to the position 420 where the second touch event is detected, 1 cm as a length of a line connecting the position 420 where the second touch event is detected to the position 430 where the third touch event is detected, 3 cm as a length of a line connecting the position 430 where the third touch event is detected to the position 440 where the fourth touch event is detected, and 1 cm as a length of a line connecting the position 440 where the fourth touch event is detected to the position 410 where the first touch event is detected.

The display unit 115 displays an area, for example, 3 cm², using a mathematical formula of calculating an area of a quadrangle. Then, the display unit 115 displays a selecting screen 450 for selecting an input of a height necessary for calculating a volume. When a user selects the selecting screen 450, the display unit 115 displays an input screen for inputting a height.

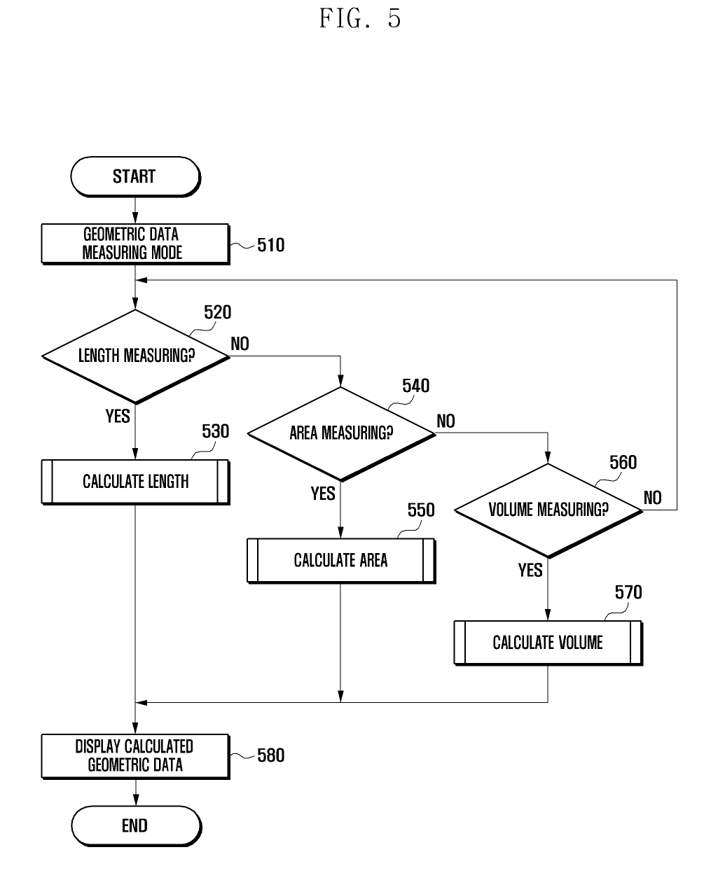

Next, a method of measuring geometric data in the terminal is described with reference to FIGS. 5 to 8.

FIG. 5 is a flowchart illustrating a method of measuring geometric data according to an exemplary embodiment of the present invention.

Referring to FIG. 5, the terminal enters a geometric data measuring mode in step 510. In the geometric data measuring mode, a length, an area, or a volume of a specific object may be measured, and the mode may be selected, for example, from a menu or a specific function key.

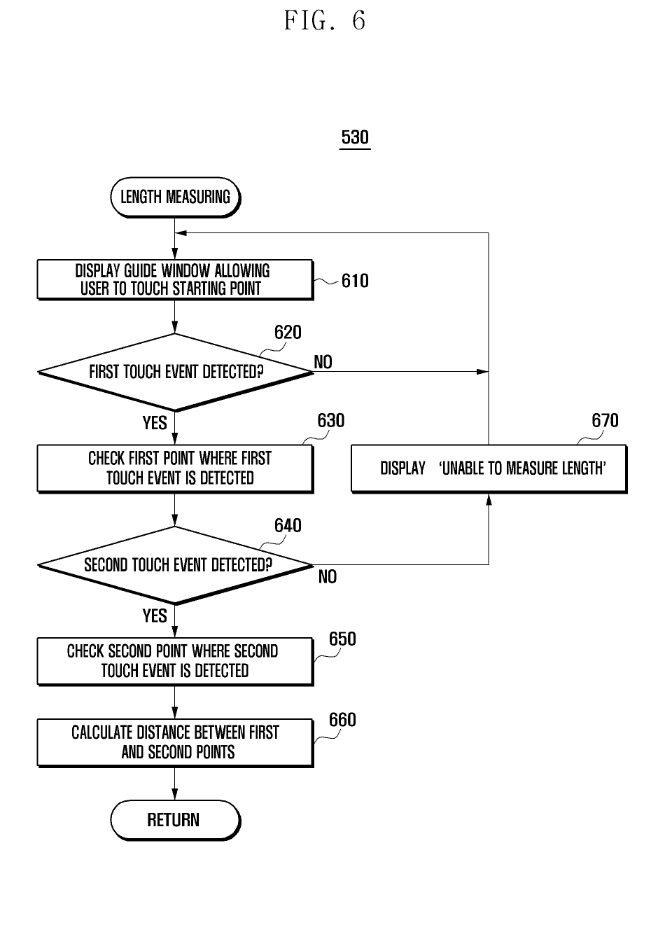

Next, the terminal determines whether a length measuring is selected in step 520. If it is determined that the length measuring is selected, the terminal measures a length in step 530. The length measuring in step 530 will be described in more detail with reference to FIG. 6 below.

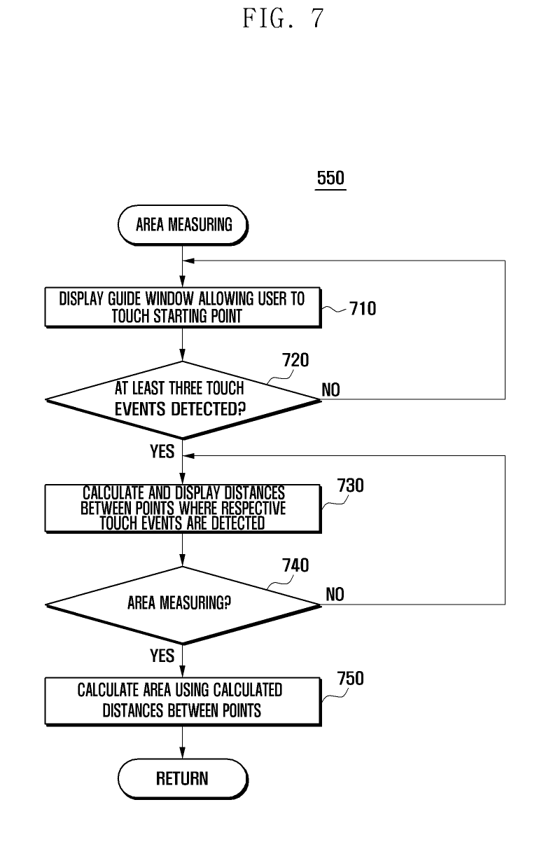

However, if it is determined that the length measuring is not selected in step 520, the terminal determines whether an area measuring is selected in step 540. If it is determined that the area measuring is selected, the terminal calculates an area in step 550. The step 550 will be described in more detail with reference to FIG. 7 below.

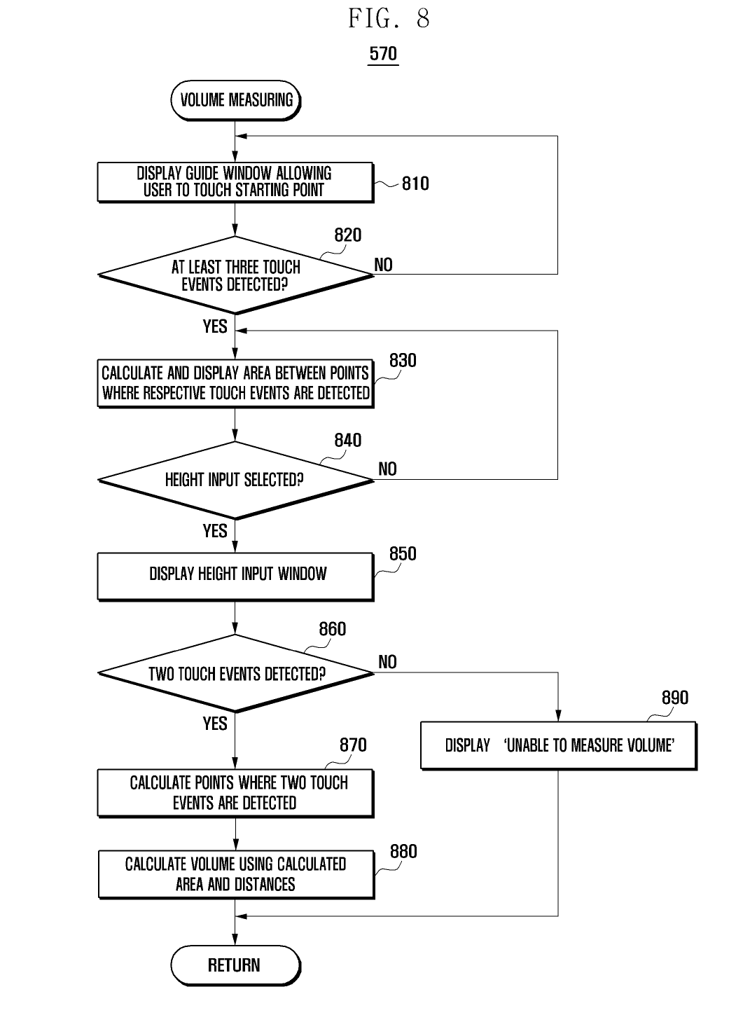

On the contrary, if it is determined that the area measuring is not selected in step 540, the terminal determines whether a volume measuring is selected in step 560. If it is determined that the volume measuring is selected, the terminal calculates a volume in step 570. The step 570 will be described in more detail with reference to FIG. 8 below.

Next, the terminal displays geometric data respectively calculated in steps 530, 550, and 570, in step 580. By doing so, a user can measure a length, an area, and a volume of a specific object with the terminal.

Herein, an exemplary method of measuring geometric data in the terminal has been described briefly. Next, the respective methods of measuring geometric data are described with reference to FIGS. 6 to 8 in more detail.

FIG. 6 is a flowchart illustrating a method of measuring a length according to an exemplary embodiment of the present invention.

Referring to FIG. 6, when the length measuring is selected, the control unit 120 controls the display unit 115 to display a guide window, such that a user touches a starting point for the length measuring in step 610. By doing so, the user may input an object, a length of which is to be measured, on the touch screen 110, and may touch a starting point for the length measuring.

The control unit 120 determines whether a first touch event for inputting the starting point of the length measuring is detected in step 620. If it is determined that the first touch event is detected, the control unit 120 checks a first point where the first touch event is detected in step 630. Next, the control unit 120 determines whether a second touch event for inputting an end point of the length measuring is detected in step 640. If it is determined that the second touch event is detected, the control unit 120 checks a second point where the second touch event is detected in step 650.

The control unit 120 calculates a distance between the first point where the first touch event is detected and the second point where the second touch event is detected in step 660. Here, the distance between the first point and the second point may be calculated using coordinates of the positions that are transmitted to the control unit 120 through the touch screen 110. In this case, the control unit 120 controls the display unit 115 to connect the positions where the touch events are detected to each other into a line, in the order of the detections of the touch events, and to display the line.

When the second touch event is not detected in step 640, the control unit 120 controls the display unit 115 to display a message, “unable to measure a length,” in step 670. In this exemplary embodiment, the length measuring is performed when two touch events are detected, but the present invention is not limited thereto. That is, when a plurality of touch events is detected in the length measuring mode, the control unit 120 may connect the points where the respective touch events are detected to each other into lines, in the order of the detections of the touch events, and may display calculated lengths of the respective lines.

FIG. 7 is a flowchart of a method of measuring an area according to an exemplary embodiment of the present invention.

Referring to FIG. 7, when an area measuring is selected, the control unit 120 controls the display unit 115 to display a guide window such that a user may touch a starting point for the area measuring in step 710. By doing so, the user may input an object, an area of which is to be measured, on the touch screen 110, and may touch the starting point for the area measuring.

Next, the control unit 120 determines whether at least three touch events are detected for the area measuring in step 720. If it is determined that at least three touch events are detected, the control unit 120 calculates distances between the respective points where the touch events are detected and connects the points to each other into lines, in the order of detections of the touch events, and display the lines in step 730. The control unit 120 determines whether the area measuring is selected in step 740.

If it is determined that the area measuring is selected, the control unit 120 calculates an area using the calculated distances between the positions in step 750. The area may be calculated using the calculated distances between the positions and a mathematical formula of calculating an area of an object.

FIG. 8 is a flowchart of a method of measuring a volume in an exemplary embodiment of the present invention.

Referring to FIG. 8, when the volume measuring is selected, the control unit 120 controls the display unit 115 to display a guide window such that a user touches a starting point for the volume measuring in step 810. By doing so, the user may input an object, a volume of which is to be measured, on the touch screen 110, and may touch the starting point for the volume measuring.

Next, the control unit determines whether at least three touch events are detected in step 820. If it is determined that at least three touch events are detected, the control unit 120 calculates an area using distances between points where the respective touch events are detected in step 830. The control unit 120 controls the display unit 115 to display the calculated area and the lines connecting the positions where the respective touch events are detected, in the order of detections of the touch events.

The control unit determines whether a height input is selected in step 840. If it is determined that the height input is selected, the control unit 120 controls the display unit 115 to display a height inputting window in step 850. Next, the control unit 120 determines whether two touch events are sequentially detected in the displayed height inputting window in step 860.

If it is determined that two touch events are sequentially detected, the control unit 120 calculates a distance between positions where the two touch events are detected in step 870. The control unit 120 calculates a volume, using the calculated area of step 830 and the calculated distance of step 870, in step 880. The volume may be calculated using a mathematical formula of calculating an area and a height. Since mathematical formulas of calculating a volume are different according to a figure of an object, the terminal may provide a selecting window for a user to select a type of an object, a volume of which is to be measured, such as a cube, a circular cone, another body of revolution, etc.

In contrast, if it is determined that the two touch events are not detected in step 860, the control unit 120 controls the display unit 115 to display a message, “unable to measure a volume,” in step 890. The volume measuring of this example is performed when two touch events are detected, but the present invention is not limited thereto. That is, the terminal may detect a value directly input by a user as a height instead of detecting the distance between two touch events as a height.

Herein, an exemplary method of calculating respective geometric data from detected touch events in a mode for calculating the respective geometric data has been described. In addition, the present invention may be embodied by a method of displaying calculable geometric data according to the number of detected touch events and of calculating the geometric data by a user's choice. For example, when two touch events are detected, the terminal displays a selecting window enabling a user to select a length measuring menu at the positions where the two touch events are detected. When the length measuring is selected by a user, the terminal calculates a length using coordinates of the positions where the two touch events are detected. In other words, the terminal may display a selecting window enabling a user to select a length measuring when the two touch events are detected, and a length measuring, an area measuring, and a volume measuring when at least three touch events are detected. The terminal may also calculate geometric data selected by the user.

The terminal may automatically calculate and display geometric data according to the number of detected touch events. In other words, when two touch events are detected, the terminal may automatically calculate and display a distance between two positions where the touch events are detected. When three or more touch events are detected, the terminal may automatically calculate and display distances between three positions where the touch events are detected, areas, and a volume.

According to the exemplary embodiments of the present invention, geometric data such as a length, an area, and a volume of a specific object may be calculated, using a plurality of touch events detected through the touch screen. As such, since the terminal can measure geometric data, a user is provided with various conveniences. Moreover, a user may directly check geometric data, of various objects as large as the terminal having a touch screen, through the terminal.

While the invention has been shown and described with reference to certain exemplary embodiments thereof, it will be understood by those skilled in the art that various changes in form and details may be made therein without departing from the spirit and scope of the invention as shown and as defined by the appended claims and their equivalents.

What is claimed is:

1. A method of measuring geometric data in a terminal comprising a touch screen, the method comprising:
determining whether at least two touch events are detected in a geometric data measuring mode of measuring at least one of a length, an area, and a volume;
calculating the geometric data from the detected touch events; and
displaying the calculated geometric data.

2. The method of claim 1, wherein the calculation of the geometric data comprises:
determining coordinates of two positions where two touch events are detected, when the two touch events are detected; and
calculating a distance between the positions where the touch events are detected as the length, using the determined coordinates.

3. The method of claim 2, wherein the distance is calculated using a number of pixels per unit length of the touch screen.

4. The method of claim 1, wherein the calculation of the geometric data comprises:
determining coordinates of two positions where two touch events are detected, when the two touch events are detected;
calculating a distance between the positions where the touch events are detected, using the determined coordinates; and
calculating the area using the calculated distance,
wherein a shape of the geometric data to be calculated comprises a circle.

5. The method of claim 1, wherein the calculation of the geometric data comprises:
calculating distances between three points, where at least three touch events are detected, respectively from coordinates of the three points where the respective touch events are detected, when the three touch events are detected; and
calculating the area using the calculated distances.

6. The method of claim 1, wherein the calculation of the geometric data comprises:
calculating an object face area, using coordinates of at least three points, where at least three touch events are detected respectively when the at least three touch events are detected;
determining whether a height is input when the area is calculated; and
calculating the volume using the object face area and the height, when the height is input.

7. The method of claim 6, wherein the inputting of the height comprises a direct input by a user.

8. The method of claim 6, wherein the inputting of the height comprises sequentially detecting two touch events in a height inputting window, and calculating a distance between positions where the two sequentially detected touch events are detected as the height.

9. The method of claim 1, further comprising connecting at least two points where the at least two touch events are detected to each other into a line in an order of inputting the at least two touch events and displaying the at least two points.

10. The method of claim 1, further comprising, when two touch events are detected, displaying a selecting window enabling a user to select a length measuring menu at positions where the two touch events are detected.

11. A geometric data measuring terminal comprising:
a touch screen including: a touch sensor for detecting at least two touch events in a geometric data measuring mode of measuring at least one of a length, an area, and a volume; and a display unit for displaying the geometric data; and
a control unit for calculating the geometric data using the at least two touch events detected by the touch screen.

12. The geometric data measuring terminal of claim 11, wherein the control unit determines coordinates of two points where two touch events are detected respectively, and calculates a distance between the two points where the touch events are detected using the determined coordinates when the two touch events are detected by the touch screen.

13. The geometric data measuring terminal of claim 12, wherein the distance is calculated using a number of pixels per unit length of the touch screen.

14. The geometric data measuring terminal of claim 11, wherein the calculation of the geometric data comprises:
determining coordinates of two positions where two touch events are detected, when the two touch events are detected;
calculating a distance between the positions where the touch events are detected, using the determined coordinates; and
calculating the area using the calculated distance,
wherein a shape of the geometric data to be calculated comprises a circle.

15. The geometric data measuring terminal of claim 11, wherein the control unit, when at least three touch events are detected through the touch screen, calculates distances between at least three points where the touch events are detected from coordinates of the at least three points where the respective touch events are detected, and calculates the area using the calculated distances.

16. The geometric data measuring terminal of claim 11, wherein the control unit calculates an object face area using coordinates of at least three points where at least three touch events are detected, when the at least three touch events are detected through the touch screen, and calculates the volume using the object face area and a height when the height is input.

17. The geometric data measuring terminal of claim 16, wherein the inputting of the height comprises a direct input by a user.

18. The geometric data measuring terminal of claim 16, wherein the inputting of the height comprises sequentially detecting two touch events in a height inputting window, and calculating a distance between positions where the two sequentially detected touch events are detected as the height.

19. The geometric data measuring terminal of claim 11, wherein the control unit controls the touch screen to connect the at least two points where the at least two touch events are detected to each other into a line, in an order of inputting the touch events, and to display the line.

20. The geometric data measuring terminal of claim 11, wherein, when two touch events are detected, the terminal displays a selecting window for enabling a user to select a length measuring menu at positions where the two touch events are detected.
